(19) United States
(12) Patent Application Publication
(10) Pub. No.: US 2018/0252505 A1
(43) Pub. Date: Sep. 6, 2018

(54) Air Space and Ground Attack System

(71) Applicant: Michael McCrea, Calgary (CA)

(72) Inventor: Michael McCrea, Calgary (CA)

(21) Appl. No.: 15/180,378

(22) Filed: Jun. 13, 2016

Related U.S. Application Data
(63) Continuation of application No. 15/173,813, filed on Jun. 6, 2016, now abandoned.

(51) Int. Cl. F41H 13/00; F41H 11/02; H05H 3/06; B64G 1/10

(52) U.S. Cl. CPC F41H 13/0068; F41H 13/005; B64G 1/10; H05H 3/06; F41H 11/02

(57) ABSTRACT

An air space and ground attack system includes a neutron beam generator operable to emit neutron beamlets from a radioactive neutron source. A plurality of carbon tubes grouped into a plurality of subsections are disposed within the neutron beam generator, downstream from the beam generator. A radiation pipe, constructed of a plurality of elongated elongated tubes, is supported by a cradle that extends along the length of the radiation pipe. The cradle is constructed of a first and a second side that are attached and supported by a series of support braces. The radiation pipe is disposed downstream from the beam generator so that neutron beamlets produced by the neutron source pass from the beam generator through the radiation pipe. Neutron beams can be used to create gamma radiation which can in-turn disable electronic equipment, such that are found in enemy aircraft, missile guidance systems, communication systems found in ground targets and/or the like.

### CROSS-REFERENCE TO RELATED APPLICATIONS

This application is a continuation of U.S. patent application Ser. No. 15/173,813, filed Jun. 6, 2016.

### FIELD OF THE INVENTION

The invention relates to satellites in geostationary orbit. More particularly to satellites in geostationary orbit equipped with air space and ground attack systems. Other embodiments include medium range neutron-beam weapons systems.

### BACKGROUND OF THE INVENTION

The existence of the neutron was discovered in 1932 by James Chadwick. Neutrons can be generated in many ways, such as, by way of example, certain types of radioactive decay involving neutron emission and certain types of nuclear reactions.

There is a general desire to provide satellites with the capability to transmit controllable neutron beams. Such neutron beams can be used to create gamma radiation and to disable electronic equipment, such as that found in enemy aircraft, missile guidance systems, command and control centers and/or the like. Such neutron beams can also be used as anti-personnel weapons on a large scale.

The foregoing examples of the related art and limitations related thereto are intended to be illustrative and not exclusive. Other limitations of the related art will become apparent to those of skill in the art upon a reading of the specification and a study of the drawings.

### SUMMARY OF THE INVENTION

In view of the foregoing disadvantages inherent in the known types of systems now present in the prior art, the present invention provides a new satellite-based ballistic missile defense system wherein the same can be used to disable a ballistic missile while the missile is in flight or in their silos by exposing the missile to a neutron beam.

In one aspect, an air space and ground attack system that operates to disable an air-born target or a target on the ground by exposing either target to a neutron beam is provided. The system includes a neutron beam generation system having a neutron beam generator disposed within the neutron beam generation system. The beam generator operable to emit neutron beamlets from a neutron source. A plurality of tubes are grouped into tube subsection and disposed within the neutron beam generation system and are configured to receive the neutron beamlets from the neutron source. A radiation pipe and a radiation pipe cradle configured to support the radiation pipe, wherein the radiation pipe constructed of a series of elongated tubes positioned end to end disposed along the length of the radiation pipe cradle.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there are illustrated embodiments of the invention.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a cross-section of a beam generator as seen from the side;

FIG. 2 is a top view of the beam generator as seen from line 2-2 in FIG. 1;

FIG. 3 shows a side view of a cross section of a single carbon tube or radiation tube. It is set against a metal frame. This tube is used in the neutron generator and the elongated tubes. It shows the neutrons getting reflexed off the sides of the tube as it moves down it;

FIG. 4 is a cross section of the radiation tube seen from the side. It shows how the curved shaped of the tube's atom changes the trajectory of the neutron. This is what reduces the angle of the neutron. This fig. only shows neutrons that are landing on the approximate center of the atom;

FIG. 5 is a cross section of a carbon tube section inside beam let generator. A carbon tube section is surrounded by a lead shield. Its shows the carbon tubes and their support section. Groups of carbon tubes are grouped together by thinner carbon tubes. These tubes are laid out in the same way. The only difference is that the in the extensions there is no lead shielding used;

FIG. 6 is a cross section view which is seen from the side of the air space and ground attack system. It is mounted on the side of a satellite in a geo-stationary orbit. It shows 8 Elongated Radiation Tubes mounted in a support cradle mounted on to this satellite;

FIG. 7 is side view of a cross of the base of the air space ground attack system that is connected to the satellite. It shows the beam generator and the mechanism that moves the end of the radiation pipe;

FIG. 8 shows a cross section of the one of the Elongated Radiation Tubes and the support cradle. Seen from line 8-8 in FIG. 6;

FIG. 9 is a schematic cross section view of a neutron beam generated by the neutron beam transmission system described here as it travels through the atmosphere;

FIG. 10 is a cross section of an elongated tube;

FIG. 11 is a schematic cross-section depiction of a medium range beam generator according to a particular embodiment;

FIG. 12 is the view seen looking down the length of the medium range beam generator. This view is seen from line 12-12 in FIG. 11; and

FIG. 13 shows the top view of the satellite used to deploy the medium range beam generator.

### DETAILED DESCRIPTION OF THE INVENTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

This document talks mostly about the air space and ground attack system (ASG) 10 and a satellite in a geostationary orbital (SGO) that has it. The Satellite Based Ballistic Defense system (BMD) is a neutron beam generator firing a neutron beam from a satellite in a low orbit. The BMD is used mostly against Inter-Continental Ballistic Missiles (ICBM) that have been just launched from land. These missiles will be attacked when they have climbed to a high altitude. The ASG has a range long enough that it can fired from a SGO at targets in on land. The SGO moves at the same speed as the earth rotates. This orbit puts the satellite 36,000 km above the earth. The ASG's beam can be aimed at one point on earth for an extended length of time. This allows it to start attacking ICBMs when they are still sitting in their silos ready to be launched. Important ground targets can also be attacked. It is important to note that the BMD is a short-range version of the ASG. The BMD uses the same sized neutron beam generator as the ASG does and the beam has the same power.

The BMDs and ASGs are superior to older directed energy weapons. An BMD or ASG does not waste any time between targets mixing chemicals together to create a laser beam. It has a simple construction with only one moving part so it will have few technological problems, most of the parts used are inexpensive and the BMD beam can be generated for 2 years.

The ASG is producing neutrons continuously that are formed into a beam which passes through the atmosphere, the beam emits gamma rays along the whole length of it and in all directions. So the ASG's beam only has to be close the missile to destroy it. This beam can be aimed at the missile for a prolonged period of time if the missile doesn't explode right away. If the missile is above the atmosphere the beam can be widen so it is easier for the beam to hit it. The ASG I refer to are only used in SGO.

Using an ASG has addition benefits over the BMD. An ASG can have its beam generator aimed at its target constantly. The neutron beam is contained until it has to actually fire.

Because the ASG is constantly aimed at the target only one is needed as opposed to BMD where five are needed so they can always have the same orbital path warheads will take in view. The ASG can start attacking the computers in an ICBM as soon as its silo door opens. This gives the ASG more time to make sure missile is destroyed. The ASG can also attack ground targets. A beam sent from a BMD can't deal with ground targets because its beam at high altitude will be moving sideways through the atmosphere at orbital speed. All of an BMD's beam's neutrons will be absorbed by the atmosphere. The beams sent from an ASG are at all most 70 degrees to the ground so the beam can be slowly move up and down streets, military bases, or in a circle around multi-store buildings. Unlike early direct energy beams, the ASG can attack computers in air defense systems. This will eliminate the need to have send in a stealth bomber.

The ASG can take on a present day hostile ballistic missile aircraft. For example, it takes 23 ships equipped with anti-ballistic missiles to defend the U.S. against missiles launched from other countries. Several ASGs stationed over the Pacific Ocean and the Atlantic Ocean would be a lot less expensive than maintaining 23 ships. The ASG can fire at missiles no matter where they are on its path. If one of these missiles is fired at a coastal city from approximately 100 miles off the coast, the anti-missile might have less time to do to destroy it. The ASG could turn its beam on seconds after it was launched giving it a much better chance of destroying it. Also, the ASG can be used covertly and used against personnel, as anyone near the beam gets bombarded with Gamma rays. Therefore the ASG can be used to kill everyone on the ship so no more missiles can be launched.

A satellite equipped with the medium ranged generator (MNG) is used to attack hostile spacecraft that are too difficult for the ASG to attack. These targets include vehicles moving too fast in a high orbit trying to attack the ASG. Other orbiting targets include, targets that are out of range of the SNB and too difficult for the ASG to hit. The MNB would be as flexible in attacking targets that are in different directions. The satellites holding the MNB will be in an orbit that are low to medium in height. The effective range of the MNB would be a great deal longer than the SNB but a lot less than the ASG.

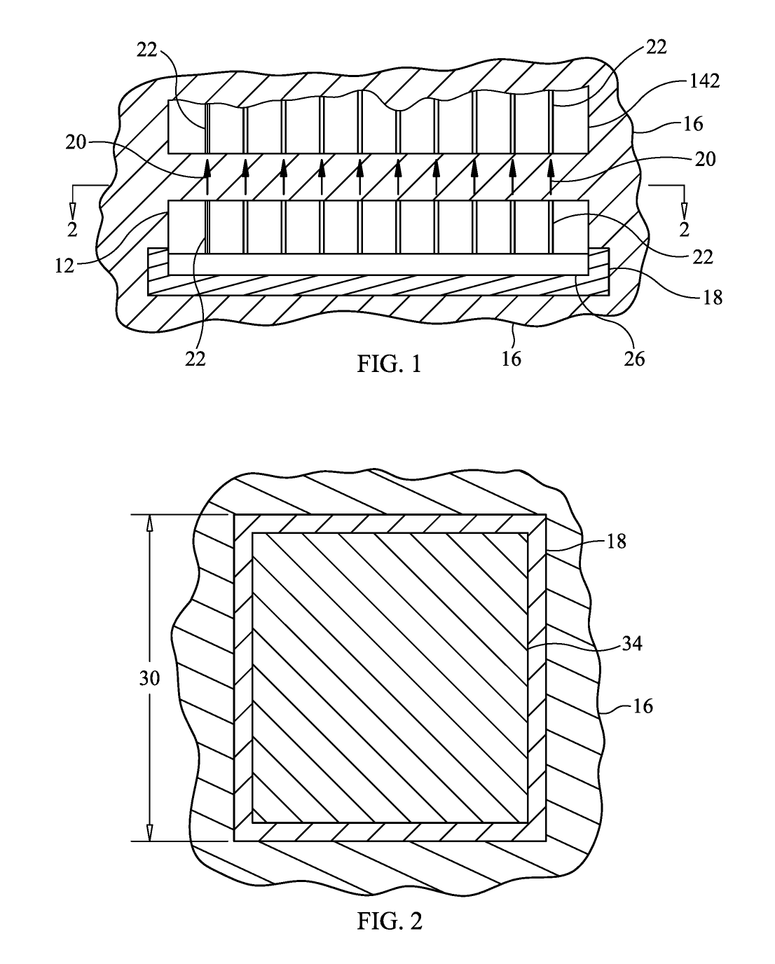

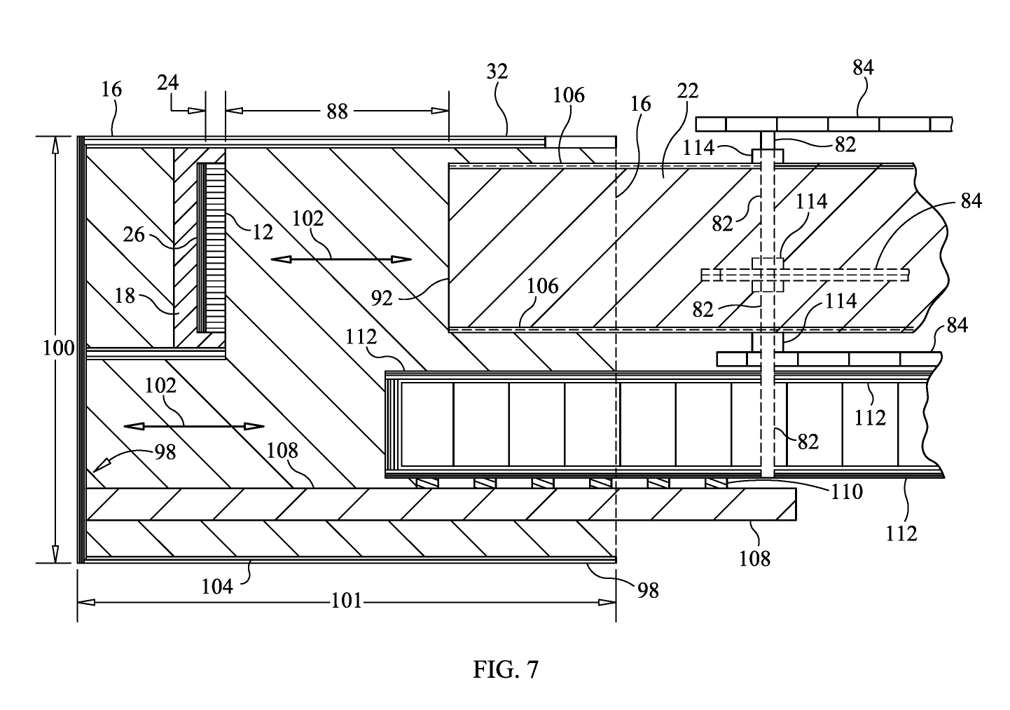

FIG. 1 shows cross section of a neutron beam generation system 12 and an elongated tube 14 from the side. The generator 12 is made up of carbon tube sections or radiation tubes supported by a larger structure 16. Which is surrounded by lead shielding 18. In FIG. 1, the neutrons 20 are given off by the radio-active source 26. The neutrons traveling almost dead straight, move up the tubes 22. The narrowing process for the angles of the neutrons 20 starts. The generator 12 is made of a suitable plurality of tubes 22. The generator 12 is about 10 cm. in thickness 24 (see FIG. 7). FIG. 7 is not drawn to scale. In FIG. 1 the tubes 22 in the generator are aligned with the tubes 22 in the tube extensions 14. In FIG. 1 the neutron 20 is sent out from the radioactive source 26 it enters the start 28 of the tube 22. When emitted from the neutron source 26, neutrons 20 may be traveling at speeds in a vicinity of 2×10⁴ miles per second enter the tube 22. The neutrons 20 not entering the tubes 22 are absorbed by the lead shielding 18. The tubes 22 are separated into sections that are divided by lead shielding 18. All the tubes 22 shown in FIG. 1 have cross-sectional dimensions of about 10×10 micrometers.

FIG. 2 is top view of the beam generator seen from line 2-2 in FIG. 1. The beam generator 12 is about 30 cm.×30 cm. in width 30. I simplified FIG. 2 and did not show all the components that you would see in a working model. I just show the support structure 16 as a back ground. The hundreds of thousands of tubes 22 and their shielding 18 that you would normally see from line 2 shown in FIG. 1 are only shown as shaded area 34.

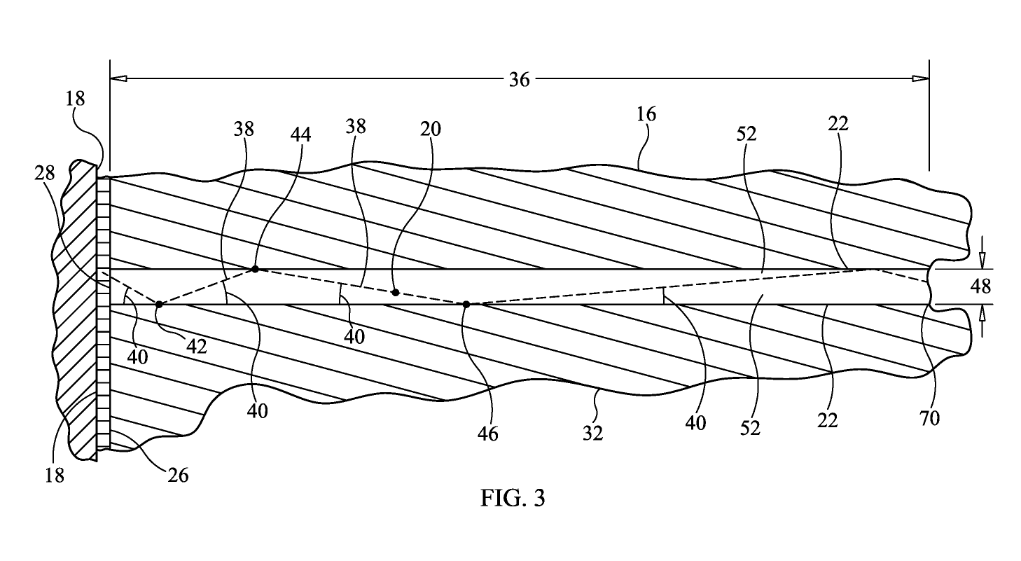

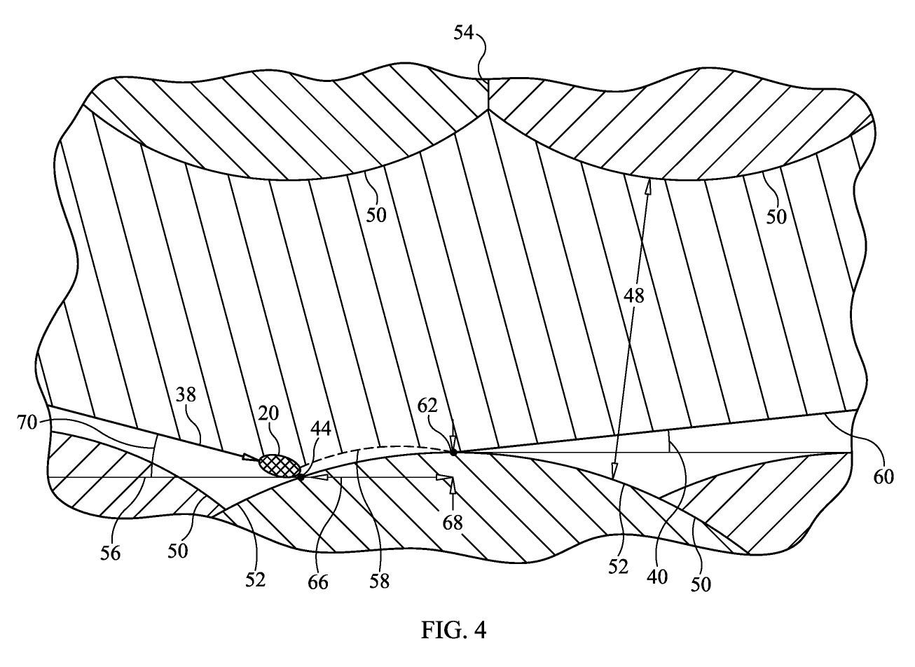

FIG. 3 shows high velocity neutrons 20 in only one of the carbon or radiation tubes 22 used in the beam generator 12. In FIG. 3 only a portion of the tube 22 is shown. This part of the tubes 22 shown here is about 5 cm. long 36. The tube 22 is set against a support structure 16 only in FIG. 3. In FIG. 3 the neutron 20 is sent out from the radioactive source 26 it enters the start 28 of the tube 22. It is enter the tube at a high velocity. Its path 38 is at an angle 40 and it is first deflected at the point 42 in the tube 22. After it is deflected the angle 40 it is now traveling at is slightly less than the angle 40. When the neutron 20 strikes the tube at points 44 and 46 the neutron angle 40 is reduced in the same way. This happens multiple times as the neutron 20 moves down the tube 22 and through the different tube extensions 14. The width of the tube 22 is about 10 micrometers 48. The only difference between the tubes 22 used in the generator 12 and the ones 22 used in the extenders 14 are their length. The tubes 22 in the generator 12 and extenders 14 are as perfectly attained as possible. The angle of the moving neutron 20 to side of the tube 22 is greatly exaggerated.

FIG. 4 is a cross section of the radiation tube 12 seen from the side. It is to show in detail how the angles of the neutrons 20 are reduced as they move down the tube 22. This Fig. only shows the neutrons 20 that hit the center of the atoms 50 in the tube. Most of the neutrons 20 hit a point that is off the center of the atom 50. In theory, the neutron 20 hitting atoms 50 off center will increase the energy it loses at each deflection point 42, 44, 46. The hollow part of the carbon tube 22 are the carbon atoms 50. Line 54 divides the atoms 50. All the tubes 22 in the tube extender 14 are the same shape size and length. In the beam generator 12, tubes 22 are the same diameter as in the tube extender 14. In FIG. 4 the line 56 is parallel to the sides of the tube 22. The neutron 20 is traveling on path 38 before it strikes atom 50 at point 44. Just after the neutrons 20 hits point 44 on atom 50 its kinetic energy forces it to move along the curved line 58. As neutron 20 moves along the curved line 58 the curvature of the atom 50 is flatten out and it is no longer being pushed up the atom 50. So the momentum of the neutron 20 is now great enough that it takes off on a path that is represented by line 60. Line 60 is the path of the neutron after it moves away from take-off point 62. When the elongated tubes 14 are connected together, end to end, the radiation pipe 64 is formed. The neutron 20 will move unobstructed from the beam generator 12 to the very end 63 of the radiation pipe 64.

When the neutron is moving along line 58 it is causing the neutron to change its trajectory. The neutron does not just bounce off the carbon atom 50 like light reflexes off a mirror. This is because as neutron 20 moves long line 58 it is being forced upward. So in a millisecond neutron 20 has to move along the horizontal direction 66 while being forced to move the vertical direction 68. Because the force is expended over time and distance work is done. The work done here slightly reduces the velocity (on path 60) of the neutron 20 and it reduces the force (on direction 68) slightly. This means the departure angle 40 of the neutron 20 is slightly less the angle 70 it hit this atom 50.

Carbon or radiation tubes 22 can be used as the elongated tubes 14 because their carbon atoms are all the same size and distance apart. If the radiation tubes are formed out of other material used in the Spray and Grow method there may be atoms of different sizes and lay outs on the sides of the tubes.

The sides of the tubes is they are not flat at subatomic level. If you had a camera in a neutron 20 and it was approaching the side of the tube at a one degree angle you could see the size difference between the neutron 20 and atoms 50 that make up the sides of the tubes 22. The view from its camera it would look like you were coming up to large number of very wide hills all squeezed together. The gaps between the hills would be very slight. Most of the area of the atoms 50 the neutrons 20 can hit is relatively flat because of the size difference between the atoms 50 and the neutrons 20. Also because of slight angle the neutron 20 is approaching the atom 50.

One thing about neutrons 20 is they are not round, they are elliptical in shape. They can rotate on two axes at the same time. In theory, if the neutron 20 hits point 44 moving side-ways instead of head on, it will most likely change the direction it is spinning it.

How narrow the angle (in degrees) the neutron 20 is when it leaves the very end of the radiation pipe 64 is determined by the ratio of the width of the tube 22 to its length, and the mechanics involved in its being repeatedly deflected off the sides of the tube 22. The longer and narrower the tube 22 is, the more times it is going to be deflected.

The ASG 10 is about 80 meters long is because the angle of the neutron 20 in the tube 22 is being reduced so its bounces are further and further apart. The angle of the neutron 20 after one bounce can be reduced by a factor of 10. This may sound like a lot but the difference between 1/10,000 and 1/100,000 is microscopic. Of course there is a slight loss of energy each with each deflection.

As the difference between the angles becomes less and less, the loss of velocity and energy is further and further reduced. Because the distance after the neutron angle is reduced to 1/10,000 and 1/100,000 of a degree the neutrons may travel to say 20 meters between the 2nd and last bounce. A beam like this will be only able to travel 40,000 km and only expand so it is 3 meters wide. This will allow it to penetrate the atmosphere so it can attack ground targets. The neutron traveling at angles between about 1/10,000 and 1/100,000 of a degree don't reflect off end of the carbon tube 22 within the elongated tubes 14 that makes up the radiation pipe 64 because there angle is too low.

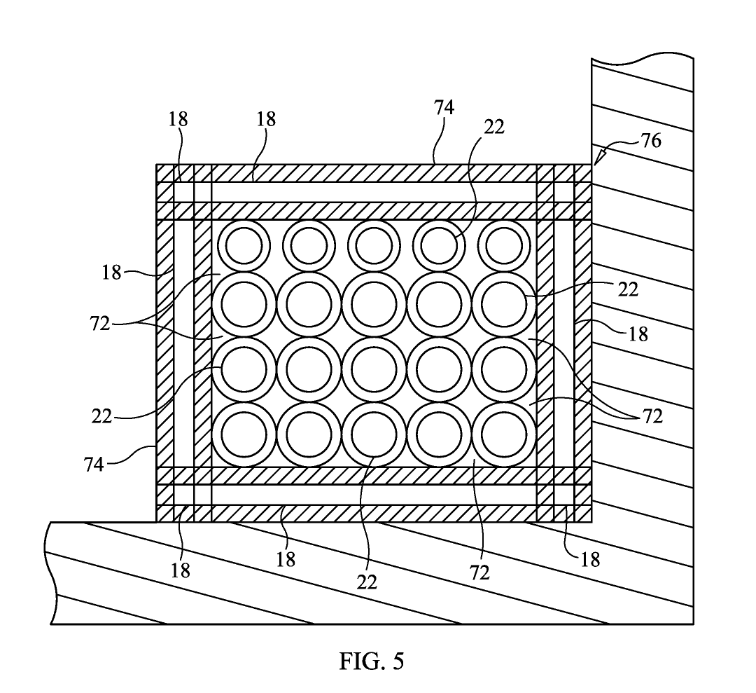

FIG. 5 shows a cross section of the tubes 22 and shielding 18 inside the beam generator 12. In FIG. 5 some of the neutrons 20 move down the tubes 22 others 20 move down the gap 72 between the tubes 22 and some are absorbed by the shielding 18. Most of the neutrons 20 going down the gaps 72 eventually come to a stop. This is because they are forced to travel into the narrow space where the tubes are touching.

In FIG. 5 the tubes 22 are all the same size, however they are not drawn to scale. The only difference between the construction of the generator 12 and the tube extensions 14 is the extensions 14 do not have the lead shielding 18 between the support tubes 74. The support tubes 74 are used to group the tubes into subsections 76. The support tubes 74 keep all the tubes 22 evenly pressed together and keep them straight. The support tubes 74 are just thinner than the carbon tubes used in the generator 12 or the tube extensions 14. In cross section, the tubes 22 used in the extensions 14 would show no lead shielding 18.

The shielding 18 in the beam generator 12 is needed otherwise the neutron 20 coming from the radioactive source 26 would form a wide cone of neutrons 20. This would be radiation hazard. In general the carbon tubes 22 are grouped into sections 76 so they can be aligned properly and so shielding 18 can be used between the subsections 76. The subsection 76 is in one corner of the generator 12. It should be understood that a larger number of tubes 22 can be used within each subsection 76. In theory, there would be a lot more tubes 22 in a subsection 76. Because the tubes 22 are only so many nano-meters wide, it is easier to position them in an organized pattern. This will make it possible to align subsection 76 instead of trying to just align thousands of tubes 22 that are loosely packed into the elongated tube 14.

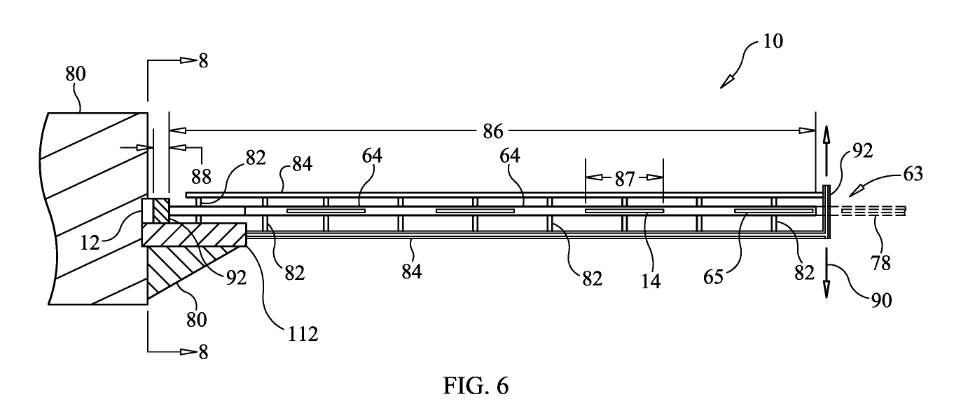

FIG. 6 shows the full length of the ASG 10 and its main components. This ASG 10 is producing a neutron beam 78. The ASG 10 is attached to a satellite 80. The satellite 80 positions and aims the ASG 10 so it can fire the beam 78 at its target. Because of the length of the ASG 10 a support brace 82 for the cradle 84 is used to help keep the ASG 10 precisely aimed at its target. The generator 12 can be seen at end of the ASG 10. All the elongated tubes 14 are joined end to end, as shown in FIG. 6, to become the radiation pipe 64. The radiation pipe 64 is about 72 meters in length 86. The adjustment gap 88 is between the generator 12 and the end 64 of the radiation pipe 64. There is about 1 millimeter of space between the elongated tubes 14 used in the ASG 10. This space is used so if there is a problem with alignment of the elongated tubes 14 there is enough clearance between them to move and realign them.

The adjustment gap 88 can be lengthened or shortened to change the diameter of the beam. To attack a ground target you want the beam as narrow as possible. For ground targets if the beam is to wide this will cause the beam's neutrons to interact with the air at high altitude and all the gamma rays to be generated at high altitude. If the ICBM that is targeted is at a very high altitude the beam is widen so its neutrons will pass through the missile and the gamma rays generated by ASG 10 will attack the missiles computers.

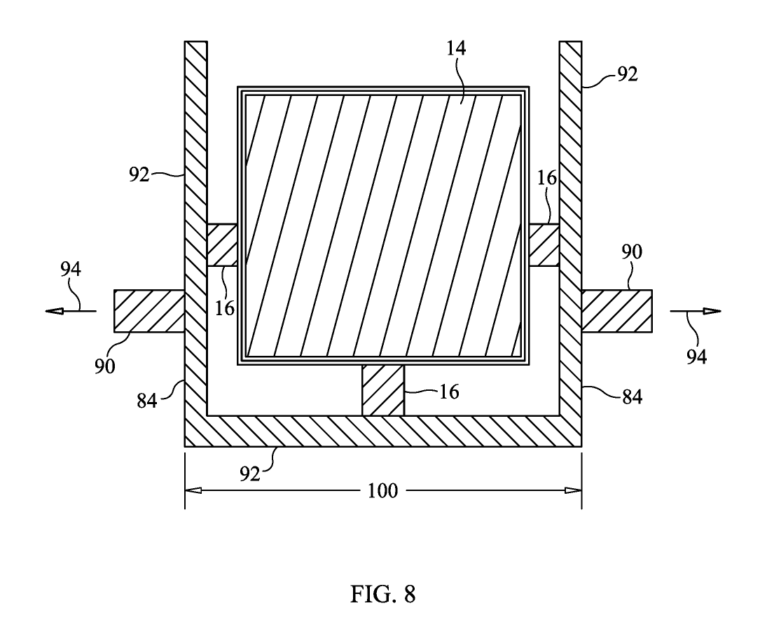

FIG. 6 shows eight elongated tubes 14 mounted a support cradle 84. This structure is mounted on to the satellite 80. The eight elongated tubes in the cradle 84 are referred to as radiation pipe 64. Each elongated tube 14 is about 9 meters long and about 30 cm. in diameter. Rocket thrust 94 (FIG. 8) from rocket motors 90 are used to change the direction of the beam 78. These motors 90 can be quite small because of the length of the cradle 84. For example, the beam only has to be moved back and forth 1/1000 of a degree to sweep back and forth. The rocket motors 90 are attached to the end piece 92 of the cradle 84 and move ASG 10 with thrust 94.

In an alternative embodiment, the last length 65 of radiation pipe 64 would rotate 180 degrees out of the beam 78, so neutron beam 78 can surround the ICBM with a wider beam 78. There are several reasons you need beams of different diameters. When the beam is 78 is passing through the lower atmosphere it relies on the gamma rays being radiated from the beam 78 to attack the missile. When ICBMs are stationary and in the lower atmosphere they are treated like ground targets. At the edge of the atmosphere and in outer space there are very few gamma rays are being radiated by the beam 78. So only the neutrons in the beam 78 passing through the missile will generate gamma rays. This will allow a beam 78 to be wider than the warhead. If the target is about 1 meter wide and 2 meters long you would want a beam about 4 meters in diameter. A beam with a larger diameter allows more room for error.

FIG. 7 shows a side view of a cross section of ASG 10, this fig. illustrates the main components of ASG 10 that are closest to the satellite 80. It shows how the variable gap between beam generator 12 and the end of the cradle 84 of the radiation pipe 64 is made possible. Beam generator 12 having a thickness 24 of about 10 cm. The gap 88 extends from the beam generator 12 to the end piece of the cradle 84. The frame 98 of the base for the ASG 10 has a length 100 of approximately 2 meters. The radiation pipe 64 moves over the distance 102 inside of the base of the ASG 10.

The motor 104 moves the cradle 84 back and forth. The outer shell 106 of the radiation tubes 22 forms the elongated tube 14. Inside box 108 are the gears and pulleys that transfer the force generated by the motor 104. The force of the pulleys is transferred to the cradle 84 by the moving brackets 110. The cradle guide 112 is connected the cradle 84 and in practice, cradle guide 112 is longer than what is shown in the FIG. 7. The cross beams 82 connect the side pieces of the cradle 84 together and adds strength to the cradle 84. The boxes 114 contain the sensors, motors and brackets. The sensors detect any misalignment of the elongated tube 14 and they signal the motors to realign the elongated tubes 14. The brackets connect the motors and the sensors to beams in the cradle 84. In FIG. 6, the cradle guide is not covered by the frame 98. Frame 98 has an edge 16.

FIG. 8 illustrates the end piece 92 of the cradle 84. Four rocket motors 90 are attached to it. For illustrative purposes, only 2 rocket motors 90 are shown. A cross section of the cradle 84 is illustrated in FIG. 8. This view does not show the satellite 80 at the other end of the cradle 84 or the neutron beam 78 coming out of the radiation pipe 64.

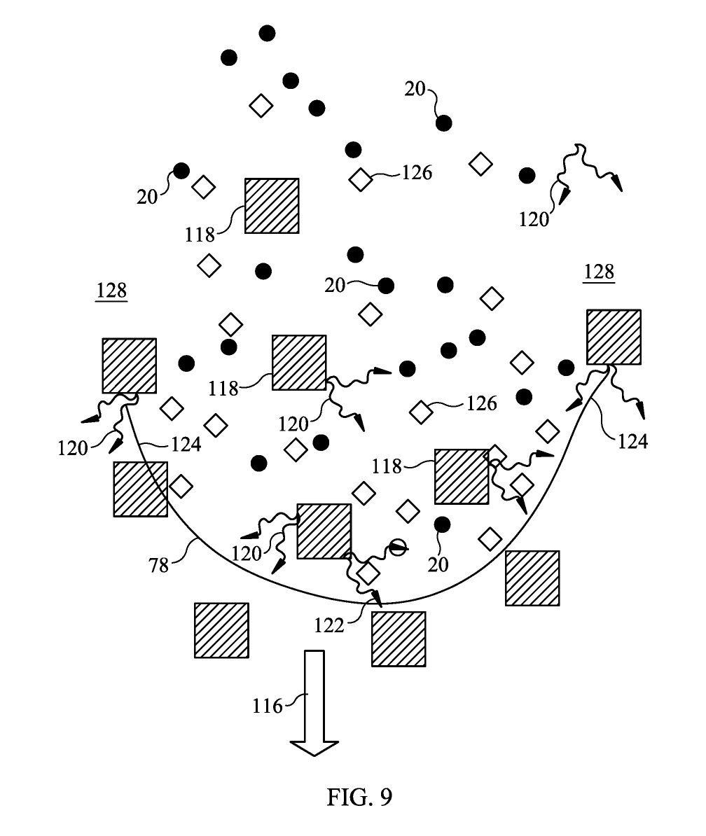

FIG. 9 is a schematic magnified depiction of neutron beam 78 traveling in the direction of arrow 116. Neutron beam 78 may be generated by any of the neutron beam transmission systems described herein. Neutron beam 78 may comprise one or more constituent neutron beamlets produced by beam generator 12. Such beamlets may join together to become, effectively, a wider single beam 78 of neutrons 20 after traveling hundreds or thousands of kilometers. Such beamlets may join to produce the composite neutron beam 78 because the beamlets start close together and then they evenly spread out. FIG. 7 shows neutron beam 78 penetrating the outer atmosphere where the neutrons 20 (schematically depicted as circles in FIG. 9) in beam 78 interact with air molecules 118 (schematically depicted as squares in FIG. 9).

In some applications, beam 78 will penetrate the outer atmosphere when traveling to a target at or near the surface of the earth (not shown in FIG. 9). However, this is not necessary and, in some applications, such as where the target is a missile and/or the like, beam 78 need not be directed at the surface of the earth per se, but may nevertheless pass through a portion of the earth's atmosphere. When beam 78 passes through the air in the atmosphere or through any solid object (e.g. an aircraft or missile body), collisions between neutrons 20 and air molecules 118 (or any other molecules) will generate gamma rays 120 (schematically depicted as wavy arrows in FIG. 9). Neutron beam 78 may become about 5-20 times wider (than when originally emitted from its corresponding beam transmission system) by the time it reaches the outer atmosphere. In some embodiments, the cross section of beam 78 passing through the atmosphere is in a range of 0.25 m-10 m in diameter. In general, however, the cross-section of beam 78 may have other sizes which may depend on the distances between the neutron source and the various collimating tubes.

Because of the width of beam 78, a large number of air molecules 118 may interact with neutrons 20 at or near tip 122 and sides 124 of beam 78. Air molecules 118 that penetrate into beam 78 may be deflected or broken up by collisions with neutrons 20. These collisions may create sub atomic particles 126 (schematically depicted as diamonds in FIG. 9), gamma rays 120 and other secondary radiation (not expressly shown). Most air molecules 118 do not penetrate too far into beam 78 because the high neutron density in beam 78. The deflected molecules 118 move at an angle relative to the direction of travel 116 of beam 78 and are forced to leave beam 78. Deflected molecules 118 may collide with other air molecules 118 and may prevent other molecules 118 from penetrating beam 78. Most of the secondary collisions happen in the area at or near the tip 122 and/or the sides 124 of beam 78 which may be referred to as pressure cloud 128. When beam 78 is moving through the atmosphere, the strongest part of beam 78 is in the region of this pressure cloud 128, which may help to preserve the neurons in the center and behind tip 122 of beam 78. In this manner, pressure cloud 128 may help to preserve the number of neutrons beam 78.

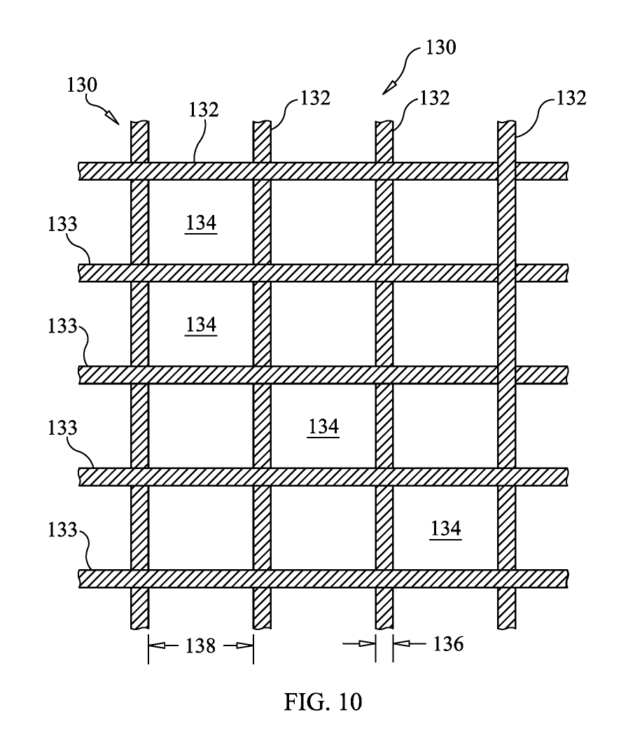

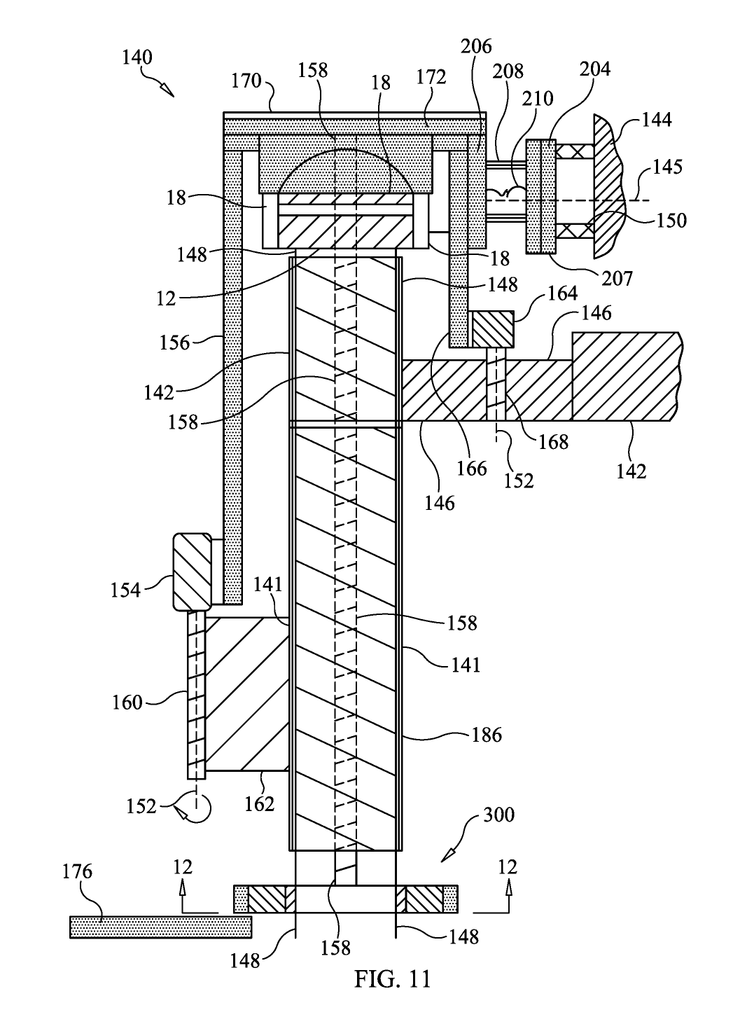

FIG. 10 shows a cross section of a small area 130 inside the elongated tube 14 that uses channels. These channels are used as radiation tubes 22. In FIG. 10 the walls 132 and floors 133 of the channels 134 have a thickness 136 of about five (5) micrometers. The channel floors 133 are shown in FIG. 11 after they have been etched by the light source and the mask. The channels 134 have a thickness 138 that are about 15 micrometers wide.

An alternative embodiment of the ASG 10 includes a Multi Range Beam Generator (MRBG). The purpose of the MRBG is to solve the problem caused by the large gap in the effective ranges of the ballistic missile defense system (BMD) and ASG 10. The main problem are high velocity spacecraft traveling in a very high orbit. The BMDs are orbiting at a very low altitude and don't have the range to hit them. The ASGs have the range to hit them but they is not able to swing around fast enough to attack the spacecraft. The other problem with swinging the ASG around too fast is that all the elongated radiation tubes 14 are thrown out of alignment. So the ASG has to spend additional time re-aligning them. The MRBG can produce 3 beams that each can have three different set effective ranges. This same system can be used with the ASG in a geo-stationary orbit.

When you are trying to hit a missile with a beam you want the beam to be wider than the missile. Even though the neutron beam 78 can stay on the missile for a minute, you may have a lot of targets to destroy in a short time. If the target is about 1 meter wide and about 2 meters long you would want a beam that is about 4 meters in diameter. A beam with a larger diameter allows more room for error. The problem you face with the wider beam is that it can only produce a beam of 4 meters in diameter for a distance of 300 km. Except a lot of the targets might be 1000 km to 5000 km away in the same orbit or in an orbit much higher. At those distances, the beams created by the BMD would be 12 meters to 100 meters wide. A beam of that diameter will be too wide and will weaken it too much. The problem with the weakened beams is solved by the MRBG because it can also produce a beam with a diameter at of 4 meters at 1000 km and 5000 km. The MRBG has the beam pass through different lengths of elongated radiation tubes to create these different beams.

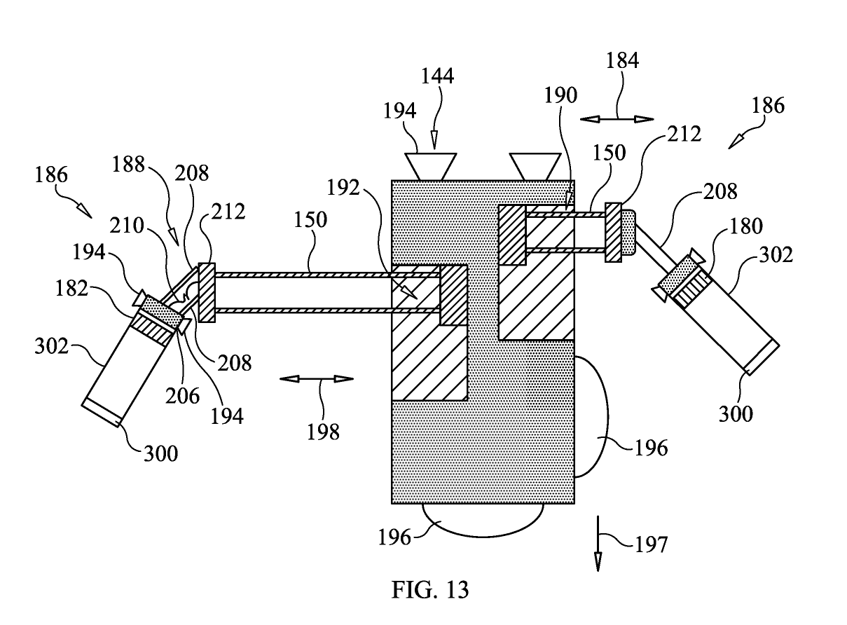

FIG. 11 is a schematic cross-section depiction of a MRBG according to a particular embodiment. System 140 comprises two elongated radiation tubes 142 mounted in a relatively low orbit (e.g. 200 km-500 km) to satellite 146, discussed below in relation to FIG. 13. The radioactive source 26 produces about one million beamlets, and the lead shielding 18 are configured in the same way as they are in the Satellite Based Ballistic Missile Defense System (SBN), U.S. patent application Ser. No. 15/008,520 which is incorporated by reference herein. Lead shielding 18 is needed in the walls to contain the cone shaped flow of neutrons coming out of the beam generator 12, this neutron cone can be angled 5-10 degrees from the center of the cone. The lead shielding 18 is included in the elongated tube 14 that is attached to the radioactive source 26 and prevents the satellite 80 and its computers from being contacted and damaged by neutrons in the cone.

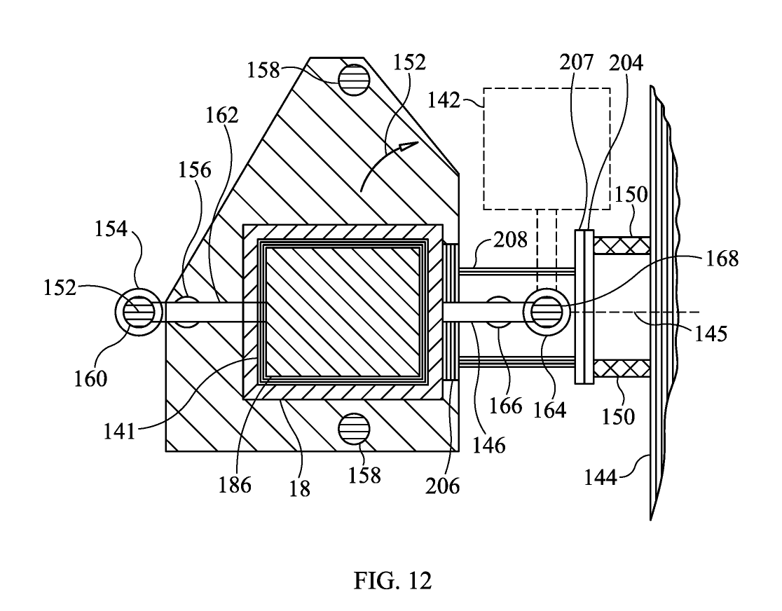

FIG. 12 is the view seen looking down the length of the MRBG 140. This view is seen from line 12-12 in FIG. 11. FIG. 12 illustrates elongated radiation tube 141 of the MRBG 140 in a first position after it has been rotated. It also shows the end view of the arms 162 and motors used by the elongated radiation tube 141. The arms 146 shown in this fig. are not drawn to scale. FIGS. 11 and 12 show how the elongated radiation tube 142 is positioned and the position of one 142 of them after it has been rotated. In FIG. 12 the lead door that is at the end of the elongated radiation tubes is not shown. Door assembly 300 connects the ends of the rods and the frame that holds the lead door.

FIG. 13 shows the top view of the satellite used to deploy the MRBG 140. This fig. shows the parts that connect it to the satellite and how the MRBG 140 can be repositioned. In this fig. the same attachment is used as in FIG. 13 to attach it to the satellite 144.

In FIGS. 11 and 12 the hydraulic arms 150 that connect the satellite 144 to system 140 will be longer when the system 140 is moved outside the satellite. The arms 150 will be longer than the elongated radiation tubes 141, 142 and will be able to rotate 180 degrees without hitting the satellite 144.

System 140 may be used as a weapon by emitting a neutron beam 78. Neutron beams 78 emitted by system 140 can provide anti-electronics (anti-computer) weapons. By way of non-limiting example, neutron beam 78 can be used to create gamma radiation and which can in turn disable electronic equipment, such as that found in enemy aircraft, missile guidance systems, communication systems and/or communication systems and/or the like.

The elongated radiation tubes 141, 142 (ET) used in MRBG 140. The eight elongated radiation tubes 14 make up the radiation pipe in FIG. 6. The ET 14 used in the MRBG is the same ones used ASG 10 expect they are of different lengths. The ET 14 work in the same way to narrow the angle the neutron beam 78 in the ASG

In the MRBG 140 the beam 78 can move through two different lengths of ET 141, 142. The elongated radiation tubes 141,142 used here are shorter versions of the elongated tubes 14 used the ASG 10 attack system. Inside the ASG 10 there are eight 8 meter long elongated radiation tubes 14 and they make up the radiation pipe 64 (see FIG. 6). In the MRBG 140 both radiation pipes can be rotated in or out of the beam to change its effective range.

Arrow 152 indicates the direction the ET 142 is rotated in. The ET 142 is rotated about 90 degrees. FIG. 12 shows a rotation of 90 degrees and FIG. 11 shows a rotation of 180 degrees.

Motor 154 is used to rotate the elongated radiation tube 141. Motor 154 is used to rotate the elongated radiation tube 141, 90 degrees. In FIGS. 11 and 12, a doted outline of elongated radiation tube 141 to illustrate the idea of how ET 142 would be configured.

In the MRBG 140 the motors 154, 164 that rotate the elongated radiation tube 141 are mounted on to the support rods 166. The motor 154 is attached on rod 156 in FIGS. 11 and 12. The motor 154 uses shaft 160 to turn arm 162 and this rotates elongated radiation tube 141, 180 degrees. On the other side of the dia. the motor numbered 164 is attached on to rod 166 in FIGS. 11 and 12. The motor 164 uses shaft 168 to turn arm 146 and this rotates elongated radiation tube 142, 180 degrees.

In FIGS. 11 and 12, rods 156, 158, 166 are mounted to anchor plate 170. In the MRBG 140 the anchor plate 170 is fixed on to the support plate 172. The motor is connected to the support rod 158 by brackets. The elongated radiation tubes 141,142 used are of three lengths (see FIG. 11). The first arrangement of radiation tubes (beamlets) 12 is attached to the radiation plate 26. The radiation tubes 12 are approximately 0.1 meters long and it 12 does not rotate. The next one, ET 142 to it is about 2 meters long and it 142 rotates. The next one over is ET 141 and it is about 4 meters long. When the net two longer elongated radiation tubes 141/142 are in line with the beamlet array 12 the beam 78 is narrowed to its maximum. Beam 78 is inline when it is passing through both radiation tubes 141, 142.

In FIG. 11 both pipes are in the stream so it have maximum range. The radiation tubes can have a combined length of about 6 meters.

System 144 is made up of a satellite equipped with two elongated radiation tubes 141/142. System 140 may be used as a weapon by emitting a neutron beam 78. To produce the beam with the shortest effective range both pipes are rotated so the beam is not moving through them. To create a medium and long-range beam, the other 2 pipes are turned so the beam is moving through them.

The MRBG (FIG. 11) uses the basic beam generator 12 that is used in the BMD but now the beam can move through radiation pipes to increase its effective range.

To contain the beam the lead door 176 is closed. It is closed and held by it's a mechanism that is attached to the end construction. The rocket motors used to maneuver the system 140 with its thrust 94, not shown in FIG. 12.

In FIG. 12 the end structure which houses the lead door 176 and rocket propulsion system. FIG. 12 shows how it would look like when seen from line 12-12 in FIG. 11. FIG. 12 shows the columns 158 that support it. There is no switch to turn the neutron beam 78 off. It can operate for 2 to 3 years after when the uranium base source 26 is manufactured. After that the uranium starts to become depleted.

FIG. 13 is a schematic depiction of a satellite 144 which is equipped with a plurality (e.g. two in the illustrated embodiment) of neutron beam generator 180 and 182. Satellite 144 may be orbiting in the direction indicated by arrow 184. As will be described in greater detail, neutron beam generation system 186 are coupled to the satellite 144 by corresponding swiveling detachable coupling 188 which permit beam generator 186 to fire at a corresponding plurality of targets at the same time.

Beam generator 186 may be housed within satellite 144 (e.g. in a compartment 190, 192) until such time as one or more of the beam generator 186 are needed. Beam generator 186 may be independently deployed. FIG. 13 shows a first beam generator 180 in a state of partial deployment and a second beam generator 182 which is fully deployed and ready to fire at a target. Satellite 144 may be equipped with rocket thrusters 194 for adjustment of the position and/or orientation of the satellite 144 with rocket thrusters 194 and suitable sensors 196 for the detection and/or Tracking of targets (e.g. enemy missiles and/or aircraft being launched). Satellite 144 may also comprise communications equipment through which it may receive positional information about potential targets which may be used in addition to (or as an alternative to) sensors 196 for detection and/or tracking of targets.

Neutron beam generation system 186 may be deployed by hydraulic arms 150 which may extend in the directions of arrows 198 to move neutron beam generation system 186 away from satellite 144. Second neutron beam generator 182 has been extended away from satellite 144 by arms 150; first neutron beam generator system 180 is partially extended away from satellite 144 on its arms 150.

As discussed above, neutron beam generation system 186 may be connected to satellite 144 by detachable couplings 188. Once arms 150 are extended, neutron beam generation system 186 may be separated from rigid contact with arms 150 and satellite 144. In particular, referring to FIG. 12, components 206, 207 may separate from one another. An example of the second beam generator 182 is shown in the FIG. 13, where the second beam generator 182 is separated from rigid contact with satellite 144 and is connected to satellite 144 by retraction cables 208 and communications cables 210. Once decoupled, in this manner, rocket thrusters 194 may be used to move neutron beam generation system 186 to adjust their orientation and to aim toward targets.

In operation, the following sequence may take place according to some embodiments. When a target (e.g. an enemy missile) is detected, a neutron beam generation system 186 is pushed out of its storage compartment 190/192 by hydraulic arms 150. The telescoping arms 208 move plate 206 away from neutron beam generator 180/182. The target is located and/or tracked using information from sensors 196 or based on information communicated to satellite 144 from other source(s) and neutron beam generation system 186 are aimed at the target (e.g. using pivotal motion of pivotable plates 212 and/or rocket thrusters 194 after decoupling of detachable plates 207). At an appropriate time, lead transmission curtain 176 may then be moved out from in front of door assembly 300 to allow transmission of a neutron beam toward the target.

When the resultant neutron beam 78 impinges on the target or passes close to the target, the gamma rays generated by neutron beam 78 will disable the electronics associated with the target. In some cases where the target is a missile, neutron beam 78 will cause the missile's warhead to detonate. Plates 206 and 207 rotate around an axis 145. In some instances, neutron beam 78 may not cause the missile's warhead to detonate on a first pass. In such instances, the neutron beam transmission system 186 may be rotated 180°. This may be done by retracting cables 208, so that rotational components 212 are re-attached to one another to facilitate pivotal motion. Then neutron beam generation system 186 is detached again for accurate aiming using rocket thrusters 196, as before.

Where satellite 144 is equipped with a plurality of neutron beam transmission systems 186, they may be independently deployed to attack multiple targets. Controller may comprise components of a suitable computer. In general, controller comprises any suitably configured processor, such as, for example, a suitably configured general purpose processor, microprocessor, microcontroller, digital signal processor, field-programmable gate array (FPGA), other type of programmable logic device, pluralities of the foregoing, combinations of the foregoing, and/or the like. Controller 504 has access to software which may be stored in computer-readable memory (not expressly shown) accessible to controller 504 and/or in computer-readable memory that is integral to controller 504. Controller 504 may be configured to read and execute such software instructions and, when executed by the controller 504, such software may cause controller 504 to implement some of the functionalities described herein.

Certain implementations of the invention comprise controllers, computers and/or computer processors which execute software instructions which cause the controllers, computers and/or processors to perform a method of the invention. For example, one or more processors in a controller or computer may implement data processing steps in the methods described herein by executing software instructions retrieved from a program memory accessible to the processors. The invention may also be provided in the form of a program product. The program product may comprise any medium which carries a set of computer-readable signals comprising instructions which, when executed by a data processor, cause the data processor to execute a method of the invention. Program products according to the invention may be in any of a wide variety of forms. The program product may comprise, for example, physical (non-transitory) media such as magnetic data storage media including floppy diskettes, hard disk drives, optical data storage media including CD ROMs, DVDs, electronic data storage media including ROMs, flash RAM, or the like. The instructions may be present on the program product in encrypted and/or compressed formats.

Where a component (e.g. a software module, controller, processor, assembly, device, component, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

While a number of exemplary aspects and embodiments are discussed herein, those of skill in the art will recognize certain modifications, permutations, additions and sub combinations thereof.

While a number of exemplary aspects and embodiments have been discussed above, those of skill in the art will recognize certain modifications, permutations, additions and sub combinations thereof.

1. An air space and ground attack system that operates to disable an air-born target or a target on the ground by exposing either target to a neutron beam, the system comprising:
a neutron beam generation system;
a neutron beam generator disposed within said neutron beam generation system, said beam generator operable to emit neutron beamlets from a neutron source;
a plurality of tubes grouped into tube subsection disposed within said neutron beam generation system configured to receive the neutron beamlets from said neutron source;
a radiation pipe;
a radiation pipe cradle configured to support said radiation pipe; and
said radiation pipe constructed of a series of elongated tubes positioned end to end disposed along the length of said radiation pipe cradle.

2. The system of claim 1, wherein said neutron source is a radioactive material.

3. The system of claim 2, wherein said radioactive material is uranium.

4. An air space and ground attack system that operates to disable an air-born target or a target on the ground by exposing either target to a neutron beam, the system comprising:
a satellite in geostationary orbit;
a neutron beam generation system on said satellite, said neutron beam generation system comprising:
a neutron beam generator having a radioactive source emitting neutrons therefrom, and plurality of tube sections each comprising a plurality of hollow radiation tubes, each radiation tube having inlet end and a discharge end, said radiation tubes arranged side-by-side with the inlet end of each radiation tube facing said radioactive source so as to receive neutrons emitted from said radioactive source through said inlet end and discharge received neutrons from said discharge, each radiation tube is constructed of a material that causes neutrons passing through said radiation tube to be deflected off the interior wall thereof and transmitted in a direction from said inlet end toward said discharge end, each radiation tube having a diameter of about 10 μm and a length of about 9 m;
wherein said plurality of tube sections are arranged end-to-end thereby forming a radiation pipe;
a cradle movably supported on a cradle guide for movement toward-and-away from said radioactive source;
a motor operatively connected to said cradle to move said cradle along said cradle guide toward-and-away from said radioactive source;
said radiation pipe supported on a cradle for movement therewith with an end of said radiation pipe facing said radioactive source; and
shielding surrounding said neutron beam generator.

5. (canceled)

6. (canceled)

7. (canceled)

8. (canceled)

9. (canceled)

10. An air space and ground attack system configured to be a multi-range beam generator defense system that operates to disable targets by exposing either target to a neutron beam, the system comprising:
a satellite in geostationary orbit;
a neutron beam generation system on said satellite, said a neutron beam generation system including:
telescoping arms;
a neutron beam generator supported by said neutron beam transmission system at one end of said telescoping arms, said neutron beam generator operable to emit a neutron beam from a neutron source;
a door assembly supported at a second end of said telescoping arms at a spaced distance from said neutron beam generator and in alignment with a neutron beam emitted from said neutron beam generator;
wherein said telescoping arms are operable to increase or decrease said spaced distance between said neutron beam generator and said door assembly; and
said telescoping arms are removeably attached to said satellite by a coupling.

11. The system of claim 10, wherein said neutron beam generator is supported for rotational movement relative to said door assembly.

12. The system of claim 10, wherein said door assembly is supported for translational movement relative to said neutron beam generator.

13. The system of claim 10, further comprising:
a transmission curtain disposed on said telescoping arms and being movable between first and second positions, wherein when in said first position said door assembly is covered by said transmission curtain, and wherein in said second position said door assembly is not covered by said transmission curtain.

14. The system of claim 10, wherein said a neutron beam generation system is mounted to said satellite in geostationary orbit for movement relative to said orbiting satellite.

15. The system of claim 10, wherein said neutron beam generator includes a radioactive source that emits neutrons.

16. A neutron beam system comprising:
a satellite in geostationary orbit;
a neutron beam generation system on said satellite, said neutron beam generation system comprising:
a neutron beam generator having a radioactive source emitting neutrons therefrom, and plurality of tube sections each comprising a plurality of hollow radiation tubes, each radiation tube having inlet end and a discharge end, said radiation tubes arranged side-by-side with the inlet end of each radiation tube facing said radioactive source so as to receive neutrons emitted from said radioactive source through said inlet end and discharge received neutrons from said discharge, each radiation tube is constructed of a material that causes neutrons passing through said radiation tube to be deflected off the interior wall thereof and transmitted in a direction from said inlet end toward said discharge end, each radiation tube having a diameter of about 10 μm and a length of about 9 m;
wherein said plurality of tube sections are arranged end-to-end thereby forming a radiation pipe;
a cradle movably supported on a cradle guide for movement toward-and-away from said radioactive source;
a motor operatively connected to said cradle to move said cradle along said cradle guide toward-and-away from said radioactive source;
said radiation pipe supported on a cradle for movement therewith with an end of said radiation pipe facing said radioactive source; and
shielding surrounding said neutron beam generator.
